(19) United States
(12) Patent Application Publication
(10) Pub. No.: US 2015/0254580 A1
(43) Pub. Date: Sep. 10, 2015

(54) METHODS AND SYSTEMS FOR SECURING VENUE RENTAL AND OPTIMIZING EVENT MANAGEMENT

(71) Applicant: EVENTFORTE, INC., Santa Clara, CA (US)

(72) Inventors: Ankit GUPTA, LOS ALTOS HILLS, CA (US); Tittu Thomas NELLIMOOTTIL, LOS ANGELES, CA (US)

(73) Assignee: EVENTFORTE, INC., Santa Clara, CA (US)

(21) Appl. No.: 14/279,221

(22) Filed: May 15, 2014

Related U.S. Application Data
(60) Provisional application No. 61/949,825, filed on Mar. 7, 2014.

(51) Int. Cl. G06Q 10/02

(52) U.S. Cl. CPC G06Q 10/02

(57) ABSTRACT

Novel methods and systems for organizing events are disclosed. A venue can provide details regarding its details, while an event organizer can provide event criteria and attendees can provide event criteria. An optimization is then carried out to find an ideal venue within the event criteria.

### CROSS REFERENCE TO RELATED APPLICATIONS

The present application claims priority to U.S. Provisional Patent Application No. 61/949,825, filed Mar. 7, 2014, and may be related to U.S. patent application Ser. No. ______, filed concurrently herewith, titled “METHODS AND SYSTEMS FOR IMPROVING SATISFACTION AND DETERMINING ITEM SELECTION AND ASSIGNMENT FOR A GROUP OF USERS” (Attorney Docket No. P1453-US), filed on even date herewith, the disclosure of both of which is incorporated herein by reference in its entirety.

### TECHNICAL FIELD

The present disclosure relates to communication and execution of venue rental involving three or more distinct parties. More particularly, it relates to methods and systems for securing venue rental and optimizing event management.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 is a flow diagram depicting an approach for storing customer preference criterion for future use in event decision making according to an embodiment of the disclosure.

FIG. 2 is a flow diagram depicting an approach for storing listed venue information for venue rental according to an embodiment of the disclosure.

FIG. 3 is a flow diagram depicting an approach for matching listed venue(s) with prospective organizer and prospective attendee preference and selection criterion and for finalizing venue decision according to an embodiment of the disclosure.

FIG. 4 is a flow diagram depicting an approach for managing an event influenced by attendee preferences according to an embodiment of the disclosure.

FIG. 5 is a diagram depicting an approach for venue rental from a venue vendor over the internet to organizers and optimizing event management for said accepted venue over the internet with attendees according to an embodiment of the disclosure.

FIG. 6 is a diagram depicting an approach for renting venue(s) to customers according to an embodiment.

FIG. 7 is a flow diagram depicting an approach for executing an event and completing related post-processing needs of an event according to an embodiment of the disclosure.

FIG. 8 illustrates a listed venue-feature graph for the present disclosure.

FIG. 9 illustrates an embodiment of a hardware implementation for the present disclosure.

FIG. 10 illustrates an embodiment of a hardware implementation for the methods of the present disclosure.

FIG. 11 illustrates an exemplary connection between server and computers for the present disclosure.

FIG. 12 illustrates an exemplary timeline of an event in relation to attendees, organizers, and venues according to the present disclosure.

FIG. 13 is a flow diagram depicting an approach for forecasting user attendance of an event according to an embodiment of the present disclosure.

FIG. 14 is a diagram that illustrates the relationship of current organizer and prospective organizer as a subset of organizer according to the present disclosure.

FIG. 15 is a diagram that illustrates the relationship between accepted venue and soliciting venue as a subset of venue according to the present disclosure.

FIG. 16 illustrates an exemplary apparatus for the methods of the present disclosure.

FIG. 17 illustrates different channels of communications according to an embodiment.

FIG. 18 illustrates sample timelines for an event according to an embodiment.

FIG. 19 illustrates differences between classification stages of attendees according to the present disclosure.

FIG. 20 illustrates how an organizer may also attend an event or venue according to the present disclosure.

### SUMMARY

In a first aspect of the disclosure, a computer-implemented method is described, the computer-implemented method comprising: providing, by a computer, venue-related details for a venue; providing, by a computer, organizer-related event constraints; selecting, by a computer, at least one venue for an event, wherein the venue is selected based on the organizer-related event constraints and wherein the selecting comprises establishing a correlation between the venue-related details and the organizer-related event constraints; and providing, by a computer, prospective attendee-related event criteria, wherein the selecting further comprises selecting the venue also based on the prospective attendee-related event criteria and wherein the selecting further comprises establishing a correlation between the venue-related details, the organizer-related event constraints and the prospective attendee-related event criteria.

In a second aspect of the disclosure, a computer-implemented method is described, the computer-implemented method comprising: providing, by a computer, venue-related details for a venue; providing, by a computer, organizer-related event constraints; providing, by a computer, prospective attendee-related event criteria; selecting, by a computer, event details based on the venue-related details, the prospective attendee-related event criteria and the organizer-related event constraints.

### DETAILED DESCRIPTION

The present disclosure relates to a computer-implemented approach for renting venues to customers, whereby the customers who wish to organize an event (“organizers”) decide what venue to rent using a specified set of selection criteria combined with aggregated preference criteria, explicitly stated and/or implicitly inferred, of expected customers attending respective events (“attendees”) who thereby influence venue rental decisions.

For example, an event could be, but is not limited to, a meal, or a presentation, video, audio that is displayed to a group of people. A venue could be a restaurant, a cinema theater, a conference room, a hotel, a cruise ship, or others. Other examples for an event are a conference, a speaking engagement, a business event with marketing stalls, a gaming event with stalls where gamers can try different games, a computer game event where players can bring their own computers or use computers at the venue, a show, such as a comedian show or a musical show, a theatrical play, an opera show, a scientific conference, a wedding, an artistic gathering, a beauty competition, a sport event where competitors can participate either individually or in teams, a sailing event, an entertainment event where participants can participate in entertaining activities, a spa event where participants can relax through various treatments, a political event, a skill competition event, such as a math competition, a skill learning event, such as an art class, an artistic event, such as an group art event, and so on.

According to the methods of the present disclosure, prospective organizers provide preference and venue selection criteria to a provider who facilitates the venue(s) rentals indicated by the preferences and venue selection criteria of the prospective organizer. These methods may be implemented on a designated apparatus such as a computer, or a system comprising several computers. Through these methods, a pre-determined price can be agreed upon for the venue rental and the venue rental can be finalized. At this time point, the prospective organizer becomes a current organizer in the context of the event.

The organizer may use and choose between various event management tools provided by the provider, for the execution and use of the accepted venue space. Subsequently, the organizer can choose a prospective attendee list for the event. The provider can inform prospective attendees of the event, who may reject or accept the event invitation. The accepted venue can arrange an event based on event management specifications and event details provided by the provider, based on preference criteria of prospective attendees, attending attendees and organizer. After the event, attendees can review the venue and the event, and modified attendee preferences and behavior can be stored and used for influencing preference criteria of events the attendees subsequently are invited to.

Conventionally in venue rentals and event management, a middle man or a prospective organizer will contract a rental space at his or her own discretion, for a fixed rental period with a venue vendor for a predetermined cost with or without a set of additional attendance or other obligations. Venue selection is ordinarily done on the basis of primary selection criteria, independently of the preferences of prospective attendees. Subsequently, after the venue is finalized, the organizer can send out invitations to prospective attendees who either accept or reject the invitation. The prospective organizer conventionally then finalizes the arrangement of the event based on his or her own interpretation of the varied needs of the attendees and of the event.

Some examples of event details may include catering, venue room arrangement, budget management and attendee overnight room bookings, which may or may not be at the same venue. These types of venue rentals and event management have significant limitations. First, conventional venue rentals require prospective organizers to make the decision of which venue to rent and how to arrange that event based on an intuitive process and their own personal preferences. This process of decision-making may result in unsatisfied attendees and potentially failed obligations on the part of the organizer with respect to the venue. Second, the tri-level process of communication between venue-organizer and organizer-attendee or vice versa, while requiring to flow through an intermediary party, results in significant communication delays for information between venue-attendee or vice versa.

Given the currently increasing year-to-year demand for venue rentals, for example, but not limited to, hotel venues, and the limitations in the prior approaches, an approach for renting to organizers that does not suffer from the limitations in conventional venue rental models is preferred. Specifically, an approach for renting listed venues to organizers that bridges the existing communication gap by providing a singular apparatus between attendees, organizers, and venues is highly desirable. There is a further need for an approach that incorporates prospective attendee preferences into the initial listed venue selection and optimized event management decisions.

For the detailed description, to clearly articulate and convey the explanation, specific details are provided herein of the invention. However, the invention can be used without these specific details.

An event could be, for example, but not limited to, a meal, or a presentation, video, audio that is displayed to a group of people. A venue could be a restaurant, a cinema theater, a conference room, a hotel, a cruise ship or others. Other examples for an event are a conference, a speaking engagement, a business event with marketing stalls, a gaming event with stalls where gamers can try different games, a computer game event where players can bring their own computers or use computers at the venue, a show, such as a comedian show or a musical show, a theatrical play, an opera show, a scientific conference, a wedding, an artistic gathering, a beauty competition, a sport event where competitors can participate either individually or in teams, a sailing event, an entertainment event where participants can participate in entertaining activities, a spa event where participants can relax through various treatments, a political event, a skill competition event, such as a math competition, a skill learning event, such as an art class, an artistic event, such as an group art event, and so on.

Various features of example embodiments of the invention are described in detail in the following respective sections: functional overview; listed venue selection criteria; preferences; listed venue selection; event management; event management tools; attendee satisfaction; organizer satisfaction; venue satisfaction; combined max “OVA” satisfaction; minimum accepted venue obligations and attendee maximization; and implementation methodology.

### Functional Overview, Venue Selection Criteria, Preferences, Venue Selection

Conventionally a prospective organizer makes the first step to organizing an event, perhaps by deciding a locale where he/she has experience organizing an event. He/she then may choose a venue quite arbitrarily, based on personal preferences or based on his/her gumption of what the attendees would like. He/she will then contact the venue and the two parties sign a contract during which the organizer will pay an advance to the venue to reserve a spot for his group on the pre-decided dates. During the time between the signing of the contract and before the commencement of the event, he/she invites his/her guests. At a pre-specified time point, the organizer makes the full payment to the accepted venue. Subsequently, the accepted venue will manage and conduct the event based on the agreement with the organizer and utilizing their own human and other resources. Even at a high level description of the process of event organization, many caveats of the process are visible.

A) The prospective organizer is often limited to searching a venue close to his/her residence or in an area where he/she has experience organizing events previously.

B) Many venues that he/she could have organized the event at are never even considered due to lack of a centralized inventory of venues that are open for group events.

C) The prospective organizer makes the choice of the venue without due consideration of how satisfied his prospective attendees would be to his choice of the venue.

D) The prospective organizer is left to his experience and gumption to make many key decisions on the contract which may end up with him/her having to bear huge losses due to lack of enough attendees, dissatisfied attendees etc.

E) The process of payment is quite cumbersome for the organizer.

F) Many processes of the event organization that require inputs from individual attendees (for example, menu decision for a meal) occurs in a haphazard manner since it is very difficult to compile and evaluate the list of all the likes and dislikes of each individual attendee.

G) The sheer complexity of all these processes makes organizing an event difficult for a layman to do without hiring a professional event organizer.

The methods of the present disclosure remove the above problems from the event organization industry. The methods of the present disclosure describe a platform which can allow controlled interaction of multiple entities with distinct functional properties, to come together to facilitate the processes pertaining to, but not limited to searching, booking, organization, management and review of an event.

Customers, Fourth Party Entities, and Venues may register themselves with the systems of the present disclosure, which may be referred to herein as the platform.

Registration may involve, but is not limited to, compiling and confirming identifying information about the entities. Each registrant may also be required to answer a set of questions relevant to the functional role of the entity they assume during registration.

Attendee-related event criteria may be user provided information pertaining to, but not limited to, personal preferences for the venue, personal location preferences, preferences related to ingredients in menu items served, seating preferences, etc. For example, the global venue feature list that the platform maintains may contain five entries: beachside, spa, gym, casino, and swimming pool. A particular user might deem a spa and a gym as absolutely necessary for a venue in order for him to be interested in attending an event. This preference can be converted into a percentage score corresponding to how important each feature is, and hence create a 5 element vector for each user.

A venue can create a portfolio by, but not limited to, adding pictures and selecting qualifying features of itself from a global feature list that the platform can provide to the venue. The platform may verify the veracity of each claimed feature independently. Every venue will choose from features from this list to best describe itself. Hence the features vector of one particular hotel could take the form (0,1,1,0,1) indicating that the venue has a spa, gym and swimming pool, but is not on a beachside and does not have a casino.

In another embodiment, venue-location preferences may include both location preferences and venue preferences.

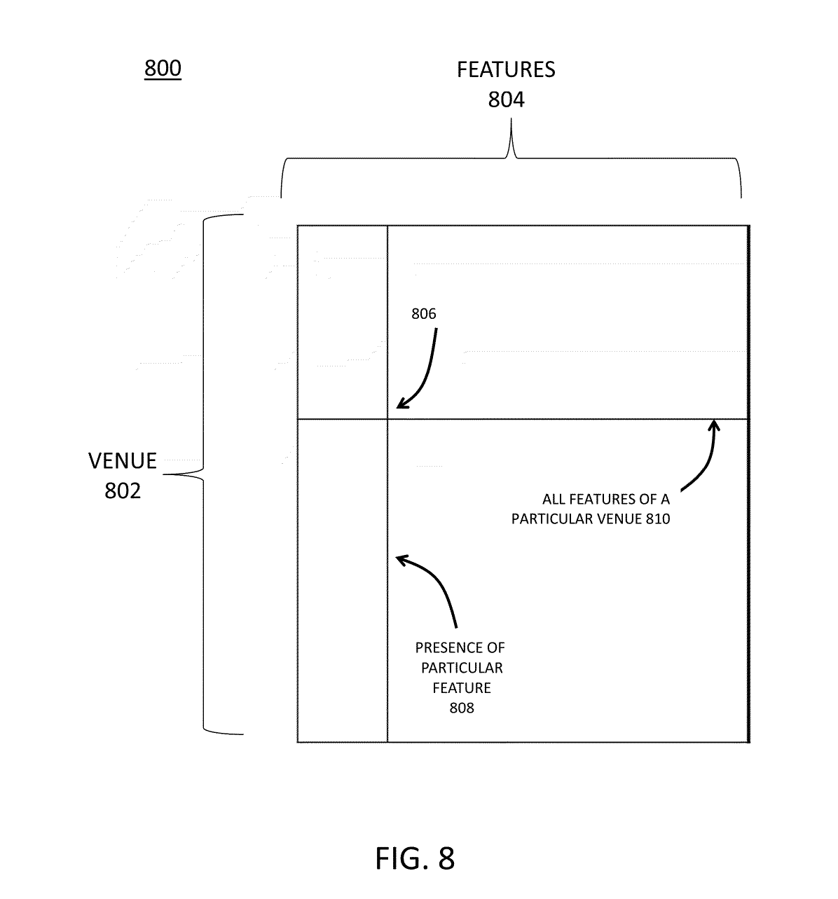

Using this data a venue-feature graph (800) can be created as described in FIG. 8. In FIG. 8, each row (810) is the features vector of one particular venue (802). A vertical line indicates the presence or absence of a feature and (808) corresponds to features data of all venues for one particular feature (804). The intersection point indicating a particular feature of a particular venue is shown via (806) as one example.

Similarly, aspects of pricing related to booking an event can be provided to the platform by each venue along with available inventory like, but not limited to, number of sleeping rooms available, number of meeting rooms available, etc., along with the times when the same are available. The venue enters into an agreement with the platform with a constraint that when a suitable prospective organizer is found by the platform, the platform will lock venue space at the venue (such as a hotel) via an agreement with the organizer.

A prospective organizer is a user of the platform who contacts the platform with the desire to organize an event. The platform may first ask the user for a sample of the prospective attendees who may be invited to the event. The prospective organizer can choose from a list of users of the platform who have agreed to share their contact information with this particular user. In another embodiment, the contact lists of an organizer for such optimization may be aggregated from alternative lists outside the platform. The user trying to organize the event, can also enter query fields such as, but not limited to, total budget for the event, number of people expected to be attending, number of meeting rooms required, minimal size of total meeting room space, dates etc.

The platform may require a number of users to be invited to be above a certain threshold, before it factors in search and sorting optimization related to the prospective attendee list. The users (“prospective attendees”) may be invited through a sample guest list. In another embodiment, this sample guest list may be limited to a subset of a prospective organizer's contact list. Based on the search queries, and the preference list of sample prospective attendees, the platform can implement various algorithms to find a list of suitable venues that can maximize or increase the satisfaction of most users from the sample prospective attendee list. This method is a tool of great advantage for a prospective organizer since it can avoid unnecessary attendee dissatisfaction related to a selected venue.

Furthermore, the returned queries may also be sorted based on various sorting criterion that the platform will provide to the user interested in organizing the event. For example, one selection criterion could be proximity to features that the prospective attendees like. The platform may store various key proximity factors in a ranked basis on a scale of 1, 2, 3, 4, 5 . . . n. In a simplified example, if the sample prospective attendees have indicated, explicitly and/or implicitly, that they, aggregately, most like sightseeing attractions, the venues returned are the ones that are close to sightseeing attractions, while maximizing or optimizing all the other prospective organizer and prospective attendee preferences. Another selection criterion could be based on risk. In a simplified example, since the platform may store historical data of the circumstances under which a user has attended an event of similar type, the platform can be able to calculate, using algorithmic tools, the likelihood that the minimum number of attendees required by the contract will be met or surpassed by the prospective organizer. This helps the prospective organizer minimize the associated risks and costs of organizing an event with a venue. In another embodiment, this likelihood can be used as a sorting value.

When the user who wishes to organize the event, makes a choice from the list of venues provided by the platform and signs a contract, physically, virtually or in any other form, he is now referred to as the “current organizer” in the context of that event. The chosen venue is now referred to as the “accepted venue”. In another embodiment, the advance is remitted from the organizer's payment source into the platform's account and then to the accepted venue's account via a payment protocol that the platform can decide. In another embodiment, the platform may choose to keep a portion of the remitted fees as its commission.

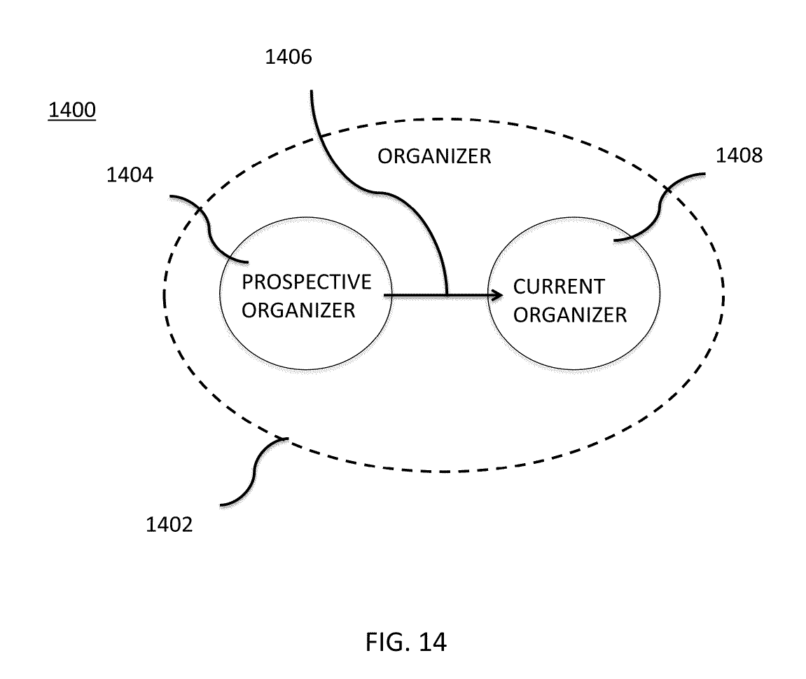

Once the event has been created, the organizer will be able to invite (additional) prospective attendees to his/her event. Any prospective attendees on the guest lists applied as part of the search/sorting may automatically be invited upon the change of a prospective organizer to a current organizer (as described in FIG. 14). In another embodiment, if a particular invitee has not registered with the platform the organizer can invite the invitee to register with the platform.

In another embodiment, the time point at which prospective attendees accept the invitation and choose to attend an event they may have to make payments. Once a prospective attendee has accepted an invitation and paid any event related fees, if any exist, they are referred to as attending attendees in the context of that event. In another embodiment, after the event, the platform will settle the final account by debiting or crediting the event organizer based on previous agreements.

An event may have organizer-related event constraints, which may be, for example, date and time of the event, what type of event it is, where the desired location of the event is, what the max budget of the event is, if the event is private or public, whether overnight rooms are needed, whether event space is needed, minimum square footage required for event space, minimum number of event rooms (or subdivisions), number of projected attendees, prospective attendee list, minimum square footage of largest event room, etc.

In another embodiment, minimum square meters or any other metric may be used in place of square footage.

In another embodiment, if an event is private, it may be restricted to registration by means of, but not limited to, only people who are specifically invited to the event or people who are associated with the contact list of the organizer, etc.

In another embodiment, this prospective attendee list may be limited to a subset of the contacts on a prospective organizer's contact list.

In another embodiment, the minimum number of overnight rooms needed may be an organizer-related event constraint.

In another embodiment, the distribution of overnight rooms on a day to day basis might be specified by the organizer.

In another embodiment, the type and quantity of each type overnight room, for example, but not limited to, king bed, double bed, suite, may be specified along with or separate from the distribution of rooms.

In another embodiment, if any organizer-related event constraint is not specified by the organizer, the provider may presume and run a search on all related permutations. In the case of overnight rooms, if type of room and distribution is not specified, the provider may presume the type of room to be “run of the house” or whatever is available at the venue, and the distribution presumed to be identical for all days. For example, if the event was 4 days, and 40 overnight rooms were set as a minimum, if a distribution is not specified, 10 overnight rooms might be presumed to be distributed for each of the four days.

In another embodiment, if a prospective attendee list is not provided, the provider may presume and run a search based on the aggregated preferences of all contacts on a prospective organizer's contact list.

In another embodiment, another default distribution might be presumed.

In another embodiment, some or all of the organizer related event constraints may be required fields.

### Event Management

All decisions regarding any event will be made by the venue based on the stipulated constraints of the organizer as well as preferences that the attending attendees and prospective attendees have confided with the platform. The tools that the platform uses will analyze data from the various preference lists, which may be composed explicitly or implicitly, or a combination thereof, of preference data, and make decisions for approval by the venue and the event organizer before finalizing.

### Event Management Tools

The platform may assist with maximizing attendee preferences and incorporating accepted venue and organizer constraints. The platform may help with resolving event details such as, but not limited to, catering, room arrangement, seating of users, optimized pick-ups and transportation, roommate matching, targeted sponsor visibility, event staff management, fourth party engagement, event schedule management, budget and financial management, and automated user and organizer specific alert and notification systems, etc., in a, but not limited to, automated or suggestive manner. Room arrangements can be specific object arrangements within a room with respect to tables, seating, etc., in an optimized and automated fashion to achieve a maximal fit for all attendees and all accepted venue restrictions such as fire codes, cost metrics, attendee preferences, etc. In another embodiment, optimal lighting and audio and visual placements may be factored into such a room arrangement.

### Attendee Satisfaction

The platform aggregates prospective attendee and attendee preferences for every event, so indirectly, prospective attendees influence every event they are invited to, at, but not limited to, the mid-processing of an event or the pre-selection of an event, having future impact on events by the same organizer or venue. Also, in doing so, it is possible to increase satisfaction of attendees' event-to-event by maximizing satisfied attendee preferences in each event.

### “OVA” Satisfaction

According to an embodiment of the invention, the preferences from the three varieties of service seekers can be combined: organizer, venue and the attendees (“OVA”). It is possible to make use of the explicitly and/or implicitly stored preference and restriction lists to automate and enable the execution of processes from the venue to the organizer and the attendee. The aggregation of preferences from all parties involved may allow for maximizing or increasing the, but not limited to, satisfaction and/or profit for a majority of the parties involved.

For example, during the search for a venue for an event, an organizer can choose a guest list of prospective attendees before making a choice of the accepted venue. This can allow for the choice of a venue that maximizes an objective function that encodes the probability that most of the members of the prospective attendee guest list will like the venue, based on a variety of factors, including, but not limited to, their original set of preferences.

Another example of the same would involve calculating the likelihood that a prospective attendee will travel to another location, attend an event based on features including, but not limited to: their travel preferences, historical travel patterns to attend events, their availability at the time point of the invited event and whether they are likely to like a venue or organizer where or by whom the invited event is hosted.

Another example of the same would be calculating the past success of events by organizer based on similar criterion, and adjusting event details and specifics such as to mitigate organizer risk.

Another example of the same would involve optimization of various event management tools including, but not limited to, pick-up and delivery of attendees from a specific location, for example, but not limited to, an airport to venue, catering and meal selection, managing event room preferences in various scenarios, and deciding seating and room arrangements in meeting rooms based on individual preferences and venue specified methods.

### Attendee Maximization

Based on an organizer's contact list, and based on prior event historical data of the organizer, prospective attendees, and similar groups of people for the subset of attendees, the platform calculates the expected attendance rates of events and may modify venue selection and event management factors, until it finds a maximal (or otherwise desirable) option based on the original prospective organizer constraints and/or the event management constraints of the venue and organizer.

### Implementation Methodology

Multiple venues can be on the platform, with multiple customers who may be attendees and/or organizers. In another embodiment, venues may also be part of the set of customers. Organizers could be organizing one or more events at the same time, and customers could be attending only a single event at the same time. If they are invited to more than one event at the same time and they commit to attending one event, their preferences may be removed or reduced from factoring into the other events. If they are added to a prospective attendee guest list of a venue search on a conflicting date as an event they are attending, the attendee preferences may not be factored into the search/sort. In another embodiment, the likelihood that they might choose to attend the latter invited event over the first invited event may be calculated and factored into the aggregate prospective attendee preferences used for the venue search. The prospective organizer may be blinded to whose preferences are being factored or excluded from the search in a variety of these logically maintained patterns.

In another embodiment, in some situations, multiple sorting criteria can provide multiple objective scores for each venue in the domain of venues being considered. It is sometimes desirable to combine the objective scores to come up with a single score to sort the venues. This can be done in many ways. One non-essential step would be the normalization (or standardization) of objective scores from each. Prior to this step, the objective scores are on different arbitrary scales. The normalization procedure could be z-normalization or quantile normalization or any other method, which allow data comparison between objective scores. After normalization, the scores can be combined by methods like, but not limited to, mean and weighted means (where the weights are either explicitly acquired from the organizer, or learnt based on prior success of events). This combined score can be used to sort the soliciting venue list.

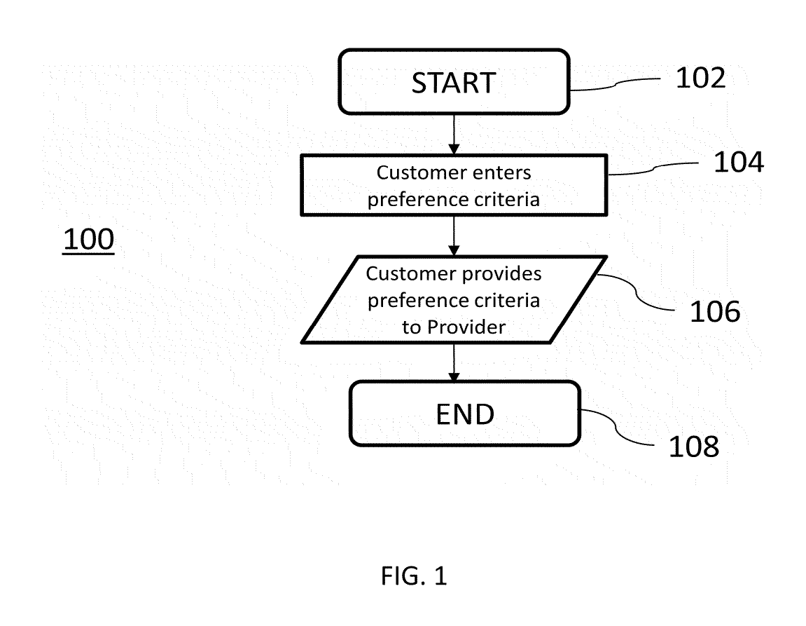

FIG. 1 may start at a point (102) and illustrates how a customer may enter preference criteria (104) and provide preference criteria (106), at which time point the process may end (108). New user initial registration process/information is stored on the platform. Preferences across a variety of fields mentioned in the functional overview section herein can either be explicitly stored and/or inferred overtime.

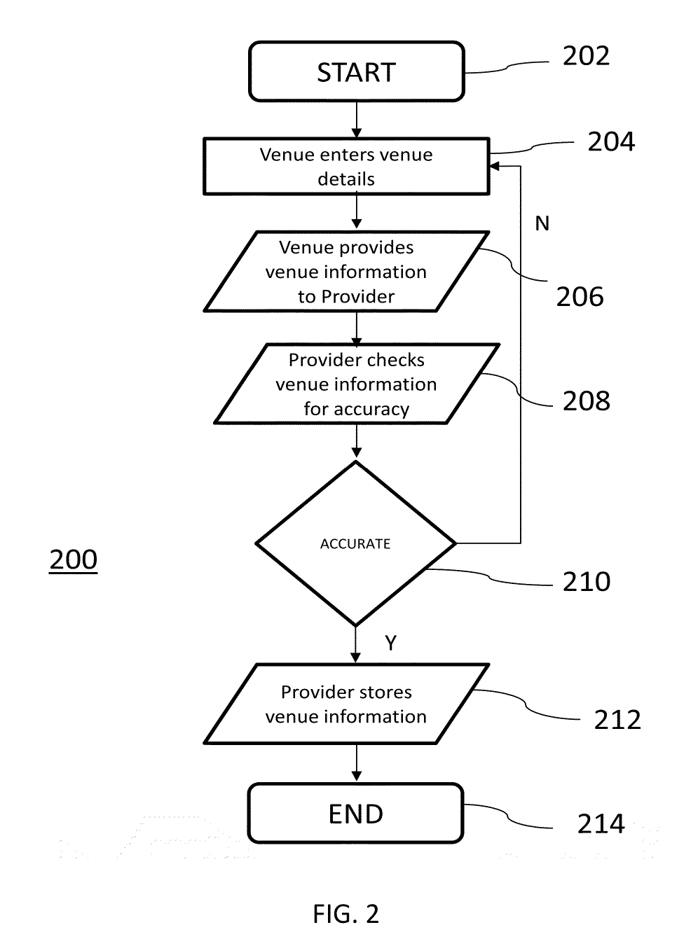

FIG. 2 illustrates the registration protocol, in one embodiment, for the registration of a new venue. Venue information can be stored on the platform, and used in the process of the search, sorting, etc., based on prospective organizer constraint requests and soliciting venue availability. The process may start (202) where a venue can enter venue details (204) and provide such information to a provider (206). Although other ways to enter venue details have not been discussed with reference to the present figure, the person skilled in the art will understand that, in a different embodiment, such details may also be included by other parties instead of the venue, such as the organizer or the attendees.

The provider can check the accuracy of the venue details (208). If the information from the venue (210) is not accurate, the venue can enter new details (204). If the information is accurate, the provider can store the venue information (212), at which point the process may end (214).

In another embodiment venue visibility during search may depend on displacement costs of, but not limited to, meeting rooms and sleeping rooms, availability of rooms etc.

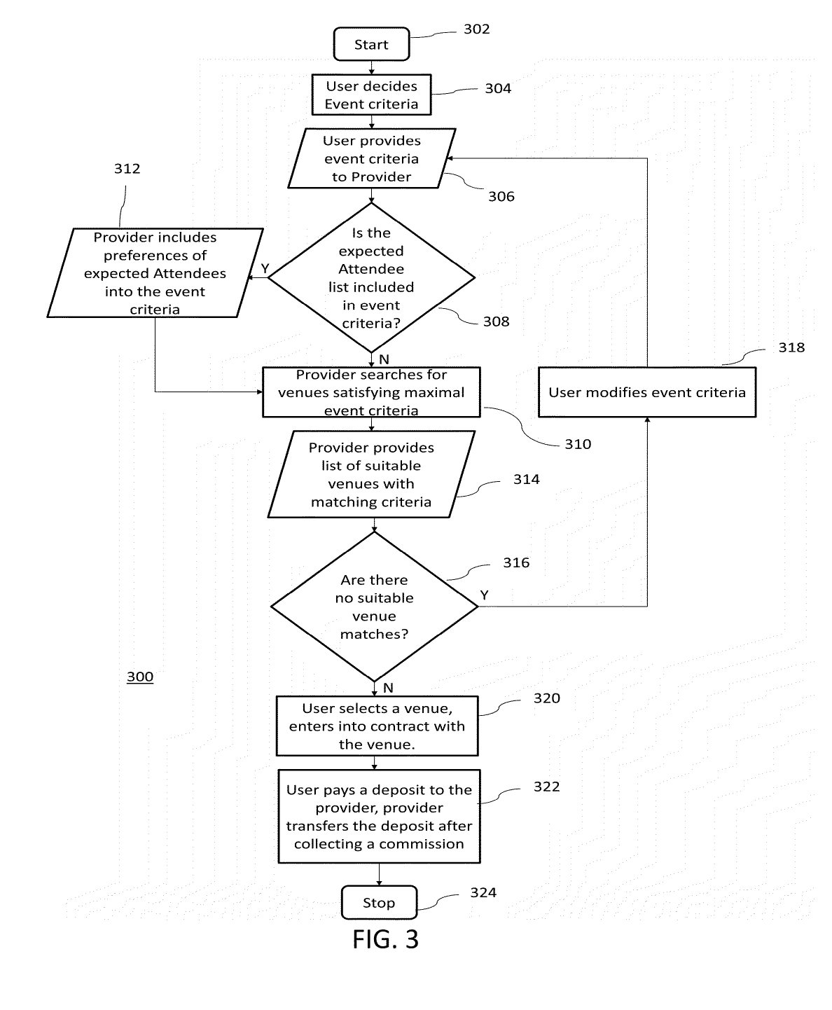

FIG. 3 illustrates an exemplary algorithm for the methods of the present disclosure. A user can decide event criteria (304) and provide such criteria to a provider (306). Then the algorithm (300) may ask whether the prospective attendee guest list is included in the event criteria (308). If it is (312) the provider can include preferences of prospective attendees into the event criteria and then proceed to step (310). If it is not, the provider searches for venues satisfying maximal or otherwise desirable event criteria. In another embodiment, if a prospective attendee guest list is not provided, the provider may include the aggregated preferences of part or the entire prospective organizer's contact list.

In step (314) the provider provides a list of suitable soliciting venues with matching criteria. The algorithm (300) then can ask if there are no suitable venue matches. If no match is found (318), then the prospective organizer can modify event criteria.

If a match is found (320), the prospective organizer selects a venue, entering into contract with the venue. At this point the prospective organizer becomes a current organizer in the context of the event, and can then (322) pay a deposit to the provider, whereby the provider may transfer the deposit. In another embodiment, the provider may collect a commission before transferring the deposit.

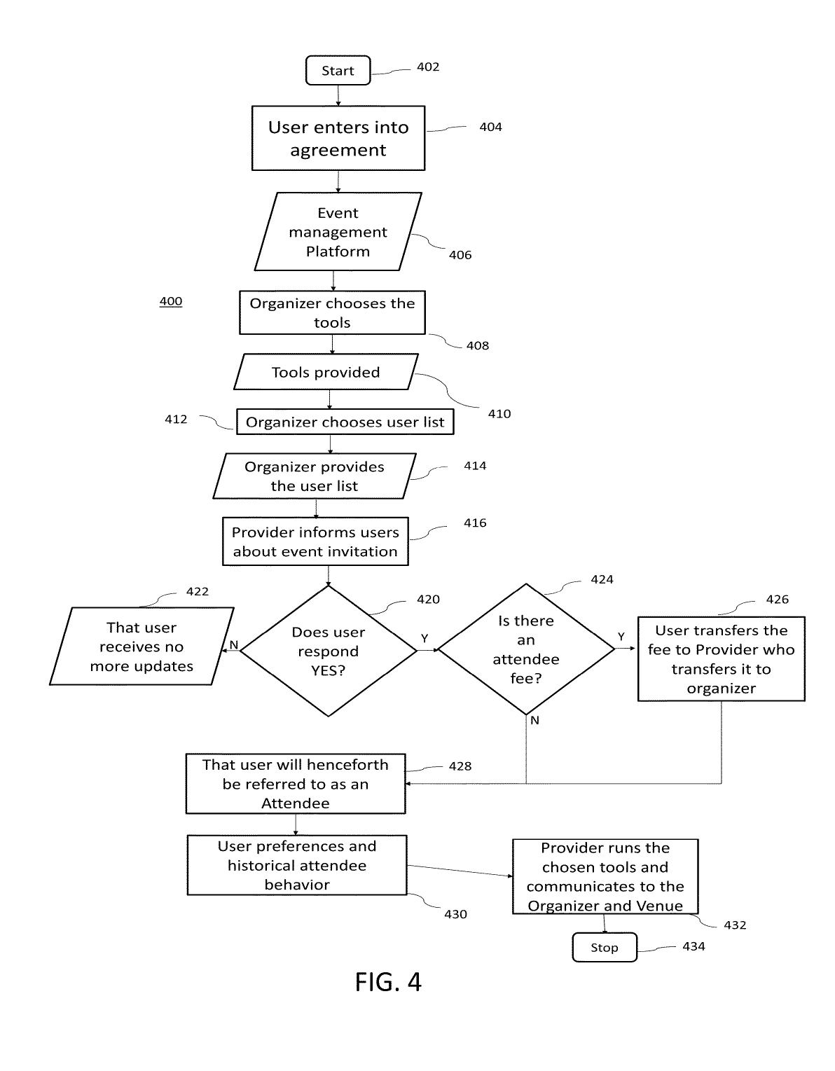

FIG. 4 illustrates another diagram for one embodiment of the methods of the present disclosure. In step (404), the prospective organizer enters into an agreement with the accepted venue through the provider and the prospective organizer is henceforth referred to as the current organizer in the context of this agreement.

In step (406), the provider provides the event management platform to the organizer. In step (408), the organizer chooses the tools he wishes to use for his event provided by the provider. In step (410), the organizer provides the provider with the set of chosen tools. The organizer can then choose a prospective attendee guest list (412). The organizer can provide the guest list to the provider (414). In another embodiment, the provider may charge the organizer for use of some tools.

The provider can then inform the prospective attendees about the event invitation along with any associated costs (416). The algorithm then asks whether the user responds YES (420). If the invitation is refused (422), that prospective attendee receives no more updates regarding this event. During the course of the invitation, at different points depending on the embodiment, the algorithm can ask whether there is an attendee fee (424).

If there is a fee, the prospective attendee transfers the fee to the provider who transfers it to the organizer (426). In some embodiments, there may be a promotional discount available in regards to the fee available to select prospective attendees. In step (428) the prospective attendee who accepted the invitation and paid an attendance fee, if one existed, will henceforth be referred to as an attending attendee in the context of this event.

In step (430), attendee preferences and historical attendee behavior are used in the event management tools to maximize or increase attendee satisfaction. In step (432), the provider runs the chosen tools and communicates to the current organizer and the accepted venue.

In some embodiments, the process of FIG. 4 or of any other methods described in the present disclosure may occur in real-time. For example, every time a user responds yes/no, the response may affect all the subsequent aggregation of user preferences and event related recommendations and suggestive parameters. In another embodiment, if a user response is heavily outside the norm of the automation or algorithmic processes, i.e. some group of people who were considered in a particular confidence level of attending, do not attend, it may affect subsequent user/platform behavior.

In another embodiment, in cases where the likelihood of the positive reply versus negative reply is above a dynamic threshold, a survey question to better improve the platform attendee behavior recognition system may be sent to the attendee. If the user responds, the platform attendee behavior recognition system can further modify the above parameters.

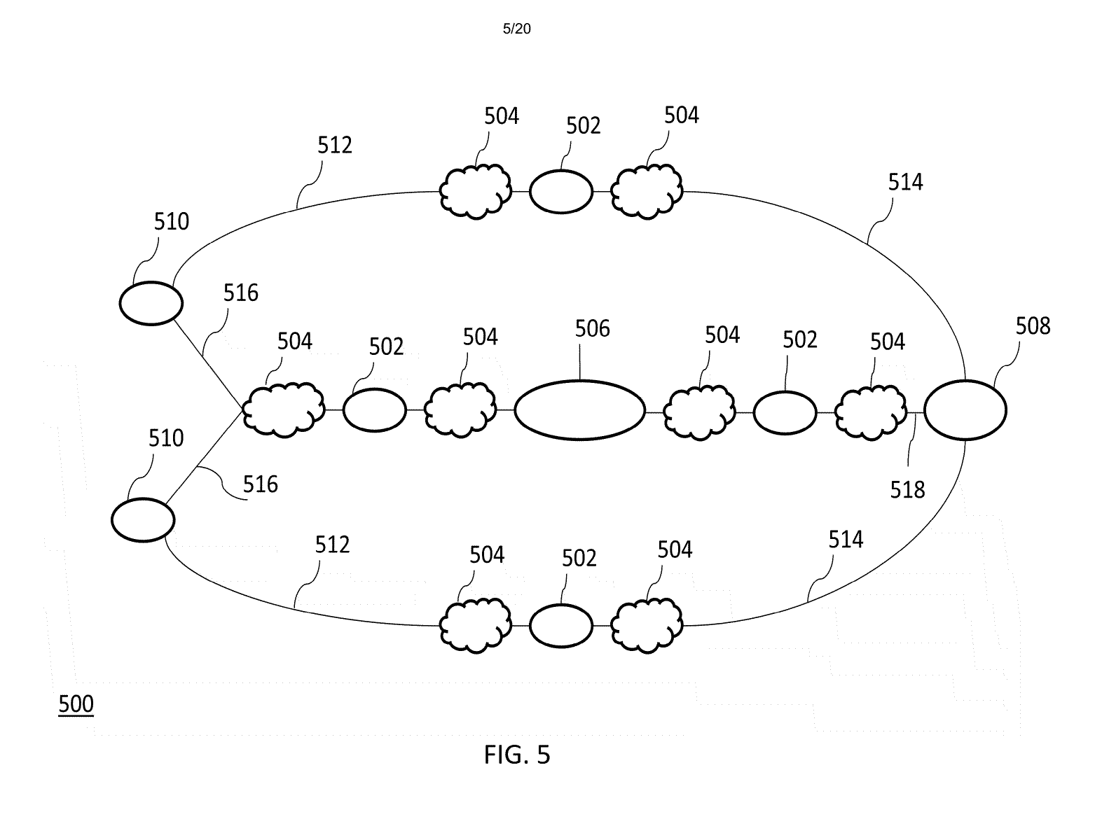

FIG. 5 illustrates an exemplary communication system (500) between attendees, venues, providers and organizers. An attendee (510) can communicate through an internet connection device (504) with a provider (502) through path (516). The provider (502) can communicate with the organizer (506) and venue (508). An attendee can communicate with a provider (502) also through channel (512), and in turn a provider (502) can also communicate directly with a venue (508) through channel (514). The organizer (506) can communicate with the venue (508) through communication channel (518) via the provider. Although fourth party vendors have not been discussed with reference to the present figure, the person skilled in the art will understand that, in a different embodiment, they may also be included in the communication system (500).

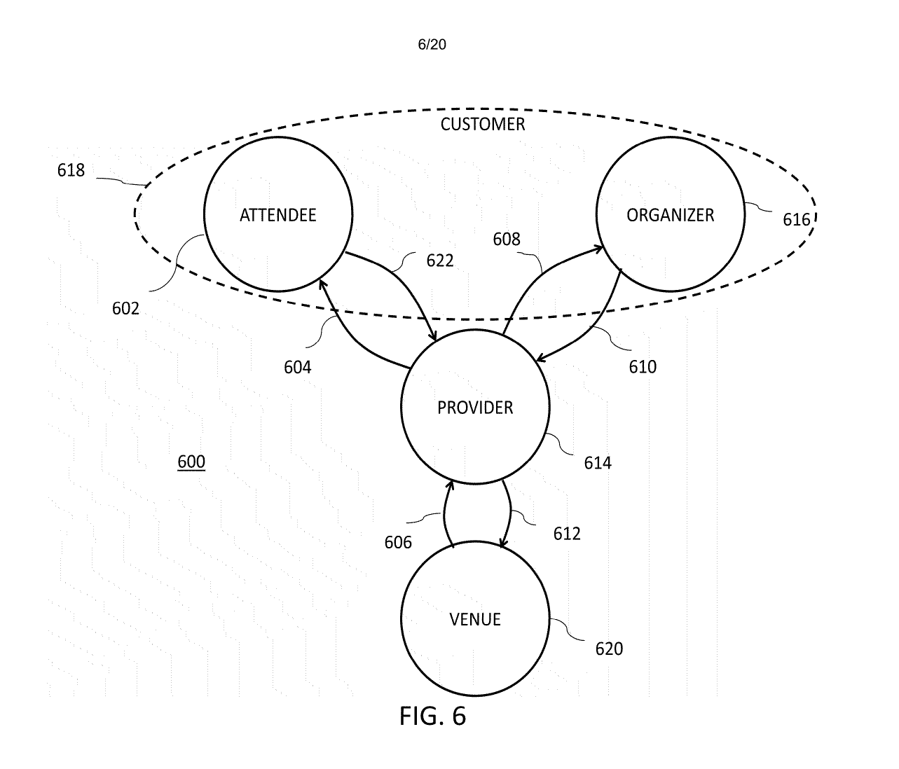

FIG. 6 illustrates an exemplary communication system (600) between attendees, venues, providers and organizers, where a provider may be somebody controlling the platform. An attendee (602) can communicate with a provider (614), or vice versa, through channels (604, 622). An organizer (616) can communicate with a provider (614), or vice versa, through channels (608, 610). A provider (614) can communicate with a venue (620), or vice versa, through channels (606, 612). Venue has been represented outside of the ‘customer’ set (618) for clarity of explanation, but additional embodiments are possible where the venue can be also seen as a customer.

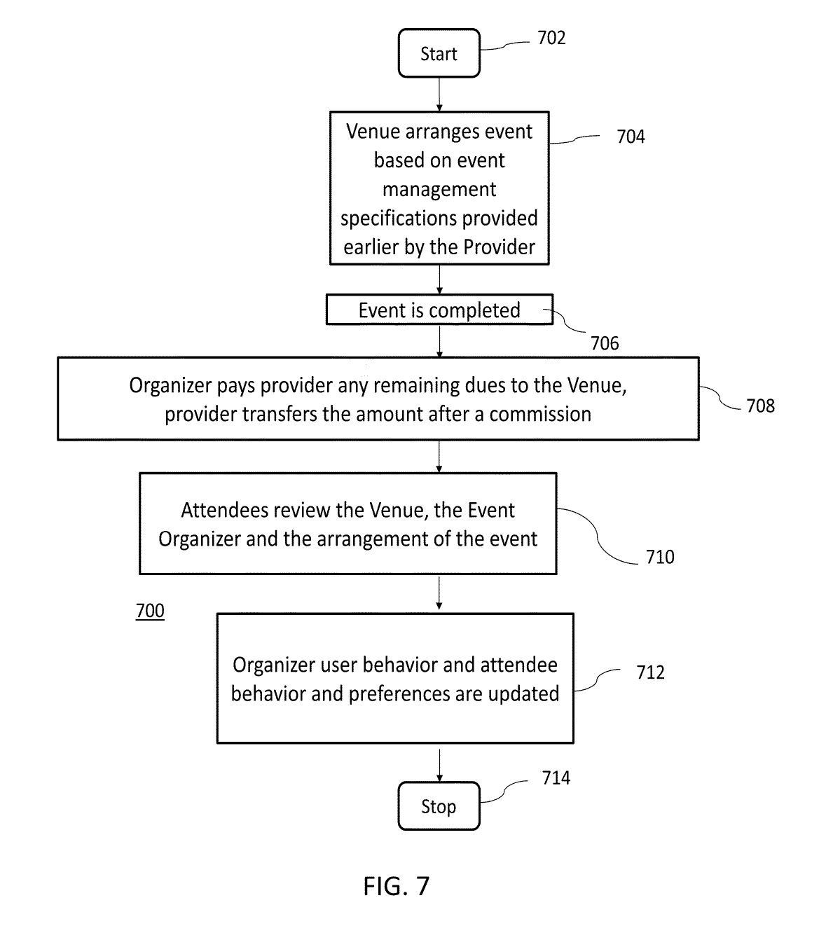

FIG. 7 illustrates a diagram for one embodiment of the methods of the present disclosure. In step (704), for an event that is currently being organized, the venue arranges the event based on event management specifications provided earlier by the provider. For example, an event is considered current when it is within a pre-specified timeframe of Y days, where Y is a venue defined number such as, but not limited to, 21 days.

In step (706) the event is completed. In step (708), the organizer pays the provider any remaining dues to the venue, and the provider transfers the amount after keeping a commission. In step (710) the attendees review the venue, the event organizer and the arrangement of the event. In step (712) the behavior of the organizer user and attendee behavior and preferences are updated.

Attendee satisfaction can be defined as a scalable metric (continuous or discrete) that assumes based on any fashion, a higher value when the attendee is assigned item instances which contain ingredients that the attendee likes more than dislikes. In another embodiment, attendee satisfaction can be a scalable metric that assumes a higher value when the attendee has more matching than non-matching preferences with a soliciting venue. In another embodiment, attendee satisfaction can be a scalable metric that assumes a higher value when the attendee has more matching than non-matching preferences with other event details. Attendee satisfaction can also assume a higher value when the attendee is assigned an item that has been rated higher by the attendee or according to the provider's records. Items that contain optional ingredients that are disliked by an attendee, may be embodied sans the disliked item and hence keep the attendee satisfied.

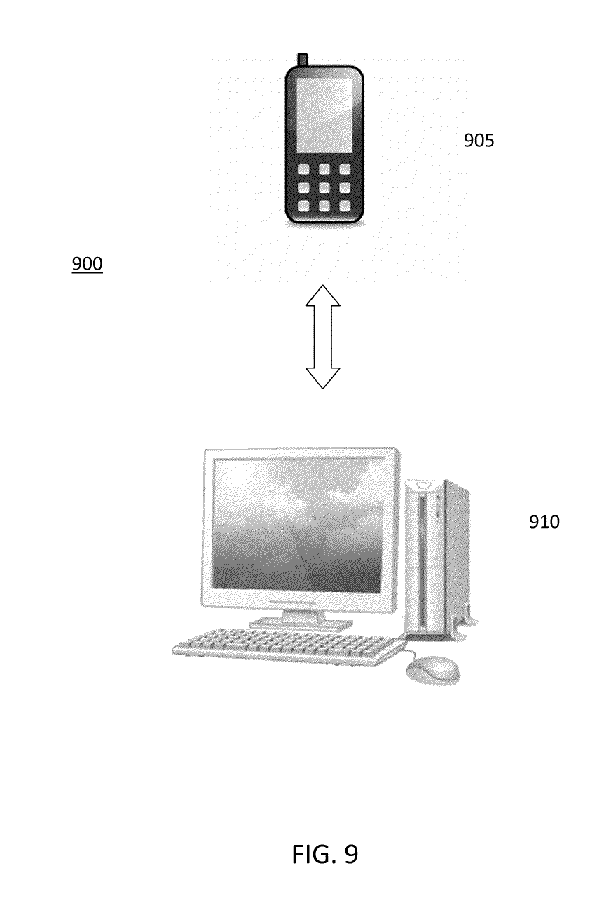

FIG. 9 illustrates an example embodiment of the present disclosure, where an application is running on a smartphone (905) and communicates with a computer (910), for example a desktop computer. For example, the smartphone may belong to an attendee and the desktop to the provider. Other hardware devices may be used, for example, but not limited to, a tablet or portable electronic device instead of the smartphone or desktop.

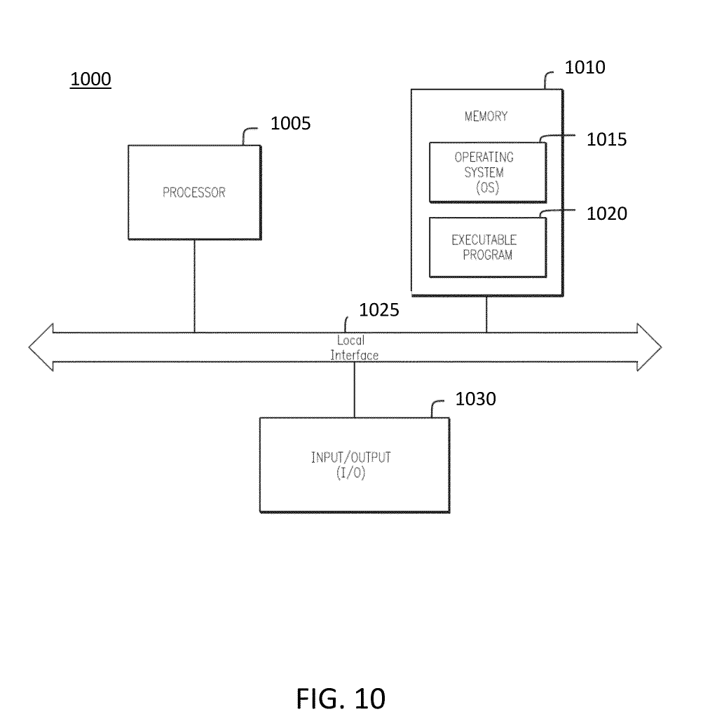

FIG. 10 is an exemplary embodiment of a target hardware (1000) (e.g., a computer system) for implementing the embodiments of other figures in the present disclosure. This target hardware comprises a processor (1005), a memory bank (1010), a local interface bus (1025) and one or more Input/Output devices (1030). The processor may execute one or more instructions related to the implementation of the other figures in the present disclosure, and as provided by the Operating System (1015) based on some executable program (1020) stored in the memory (1010). These instructions are carried to the processor (1005) via the local interface (1025) and as dictated by some data interface protocol specific to the local interface and the processor (1005). It should be noted that the local interface (1025) is a symbolic representation of several elements such as controllers, buffers (caches), drivers, repeaters and receivers that are generally directed at providing address, control, and/or data connections between multiple elements of a processor based system. In some embodiments the processor (1005) may be fitted with some local memory (cache) where it can store some of the instructions to be performed for some added execution speed. Execution of the instructions by the processor may require usage of some input/output device (1030), such as inputting data from a file stored on a hard disk, inputting commands from a keyboard, inputting data and/or commands from a touchscreen, outputting data to a display, or outputting data to a USB flash drive. In some embodiments, the operating system (1015) facilitates these tasks by being the central element to gathering the various data and instructions required for the execution of the program and provides these to the microprocessor. In some embodiments the operating system may not exist, and all the tasks are under direct control of the processor (1005), although the basic architecture of the target hardware device (1000) will remain the same as depicted in FIG. 10. In some embodiments a plurality of processors may be used in a parallel configuration for added execution speed. In such a case, the executable program may be specifically tailored to a parallel execution. Also, in some embodiments the processor (1005) may execute part of the implementation of the methods of the other figures of the present disclosure, and some other part may be implemented using dedicated hardware/firmware placed at an Input/Output location accessible by the target hardware (1000) via local interface (1025). The target hardware (1000) may include a plurality of executable programs (1020), wherein each may run independently or in combination with one another.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), a field programmable logic array (FPGA), a graphic processing unit (GPU) or a general purpose GPU).

The person skilled in the art will understand that several steps in the methods described in the present disclosure require a hardware implementation. For example, but not limited to, a tablet, smartphone, server or other computer may be needed to implement one or more steps of the methods described herein.

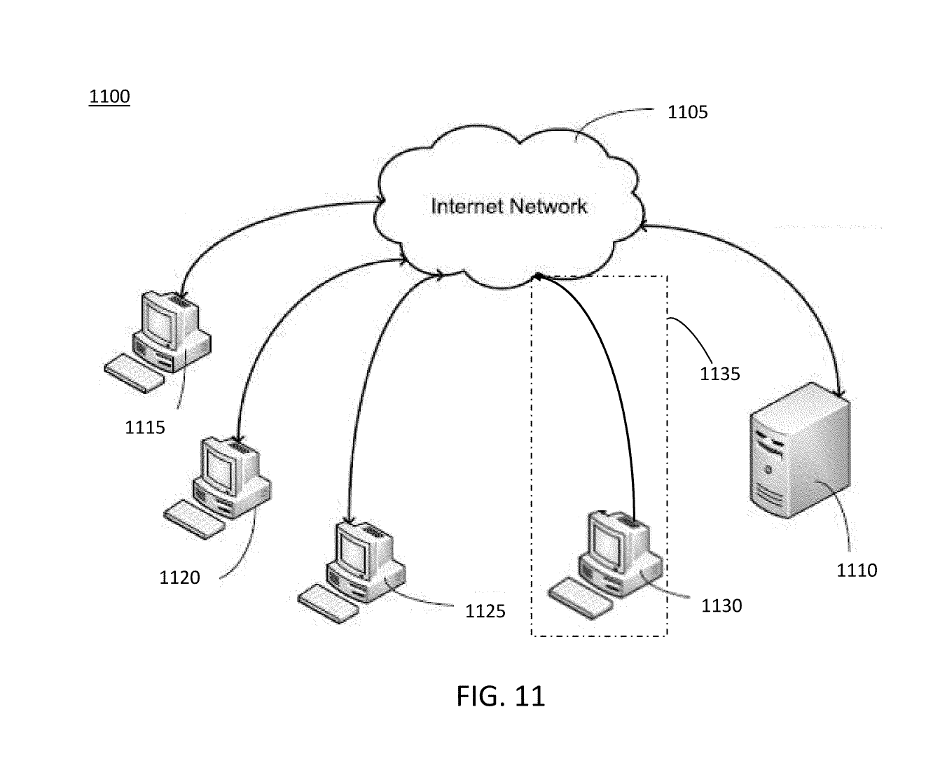

FIG. 11 illustrates an exemplary connection between a server and computers, wherein the server (1110) may run an application implementing the methods of the present disclosure. The server (1110) may connect through a network (1105) to other computers such as an attendee computer (1115), a vendor computer (1120) and an event-organizer computer (1125), and optionally (1135) also a fourth party computer (1130). A network may comprise, for example, a LAN, a WAN, or other kinds of networks as understood by the person skilled in the art. Such networks may be wholly or partly private networks.

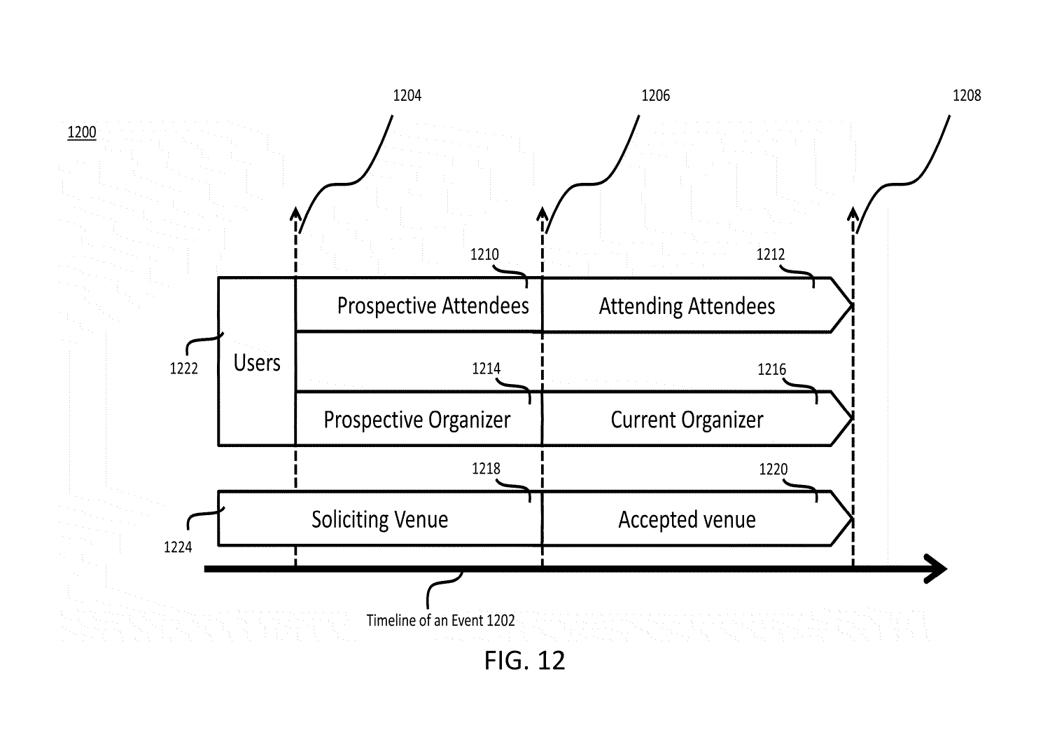

FIG. 12 illustrates a timeline (1202) of a single event with respect to the functional roles that the various entities assume. For example, a prospective organizer (1214) is a user (1222) that has initiated a venue (1224) search. At that point (1204), if he/she adds users to a tentative guest list, the users within that guest list become prospective attendees (1210). At the point when (1206) the prospective organizer (1214) selects a soliciting venue (1218), the soliciting venue (1218) becomes an accepted venue (1220), and the prospective organizer (1214) turns into a current organizer (1216). The prospective attendees (1210) on the tentative guest list are then invited to the event, and if they accept invitation, they become attending attendees (1212). The time point the event concludes is denoted by (1208).

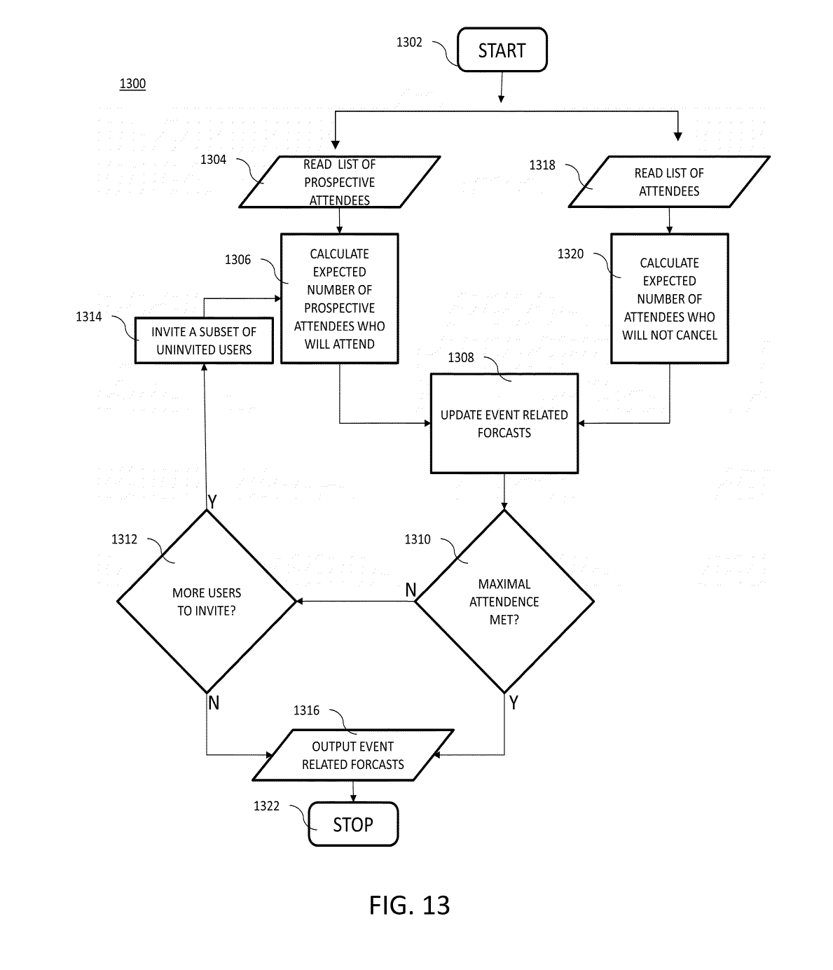

FIG. 13 illustrates a flowchart that illustrates an exemplary method for forecasting event related outcomes. The method (1300) starts (1302) and may first start with reading list of prospective attendees (1304) and calculating the expected number of prospective attendees (1306) who will attend the event based on historical behavior of each prospective attendee and other heuristics.

The method (1300) described in FIG. 13 may also start with reading a list of attendees (1318) of an event and calculating the expected number of attendees who will not cancel (1320) based on historical behavior of each attendee and other heuristic data.

Steps (1306) and (1320) may lead to updated event related forecasts (1308). If the maximal attendance is met, the method reports the event related forecasts (1316) and stops (1322). If not, the method checks to see if more users are available to be invited (1312). If no, the method reports the event related forecasts (1316) and stops (1322).

If more users are available to be invited (1312), the method may recommend a subset of available uninvited users to be invited and/or the organizer may invite a subset of available uninvited users to the event. The method then initiates step (1308) and then continues to run until completion (1322).

FIG. 14 illustrates the relationship of an organizer (1402) in the context of a single event. Prospective organizers (1404) through the channel (1406) can become current organizers (1408). Both prospective organizers and current organizers are a subset of Organizer (1402).

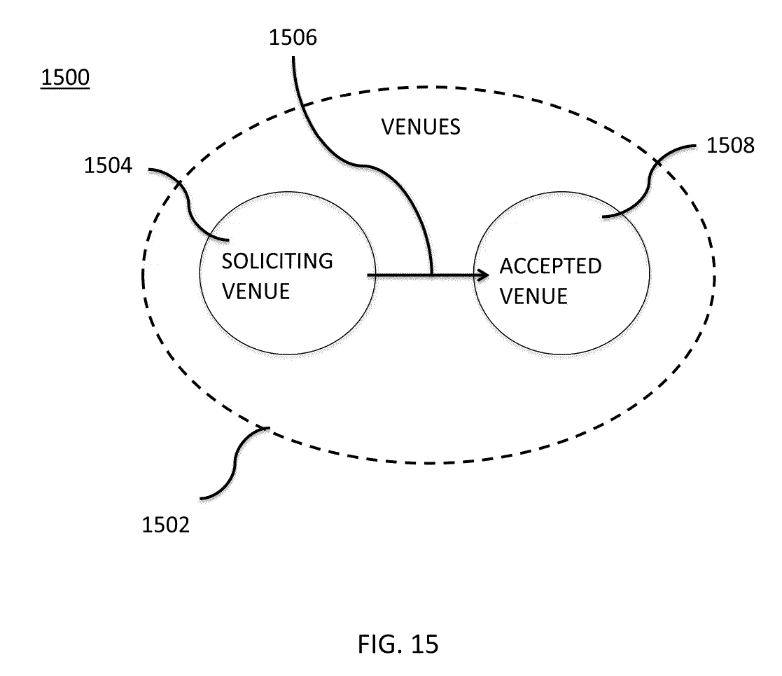

FIG. 15 illustrates the relationship of a venue (1502) in the context of a single event. Soliciting venues (1504) through the channel (1506) can become accepted venues (1508). Both soliciting venues and accepted venues are a subset of venue (1502).

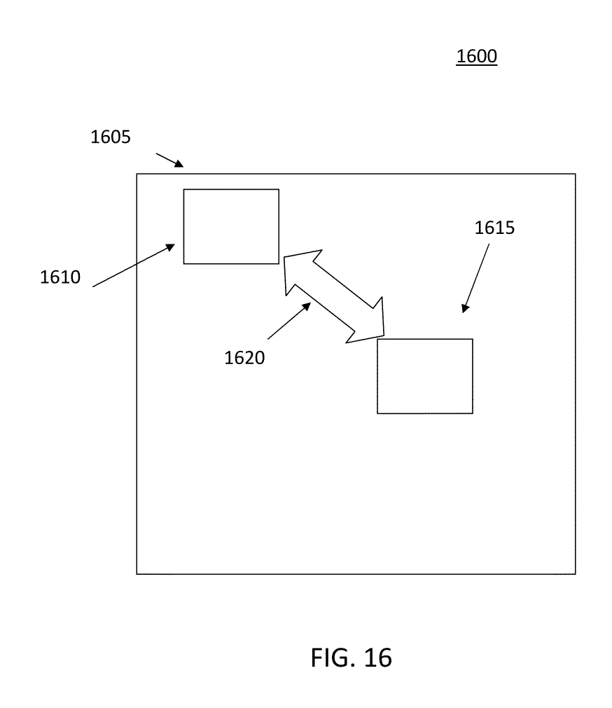

FIG. 16 illustrates an exemplary apparatus for the methods of the present disclosure. The apparatus (1605) may comprise a memory (1610) and a processor (1615) communicatively coupled to the memory. The communication may be, for example, through a bus (1620). The processor may be configured to estimate venue-related details for a venue; identify organizer-related event constraints; and execute the methods of the present disclosure. An apparatus may comprise a memory; a processor communicatively coupled to the memory, the processor configured to estimate venue-related details for a venue; identify organizer-related event constraints; and execute the method in accordance with the present disclosure.

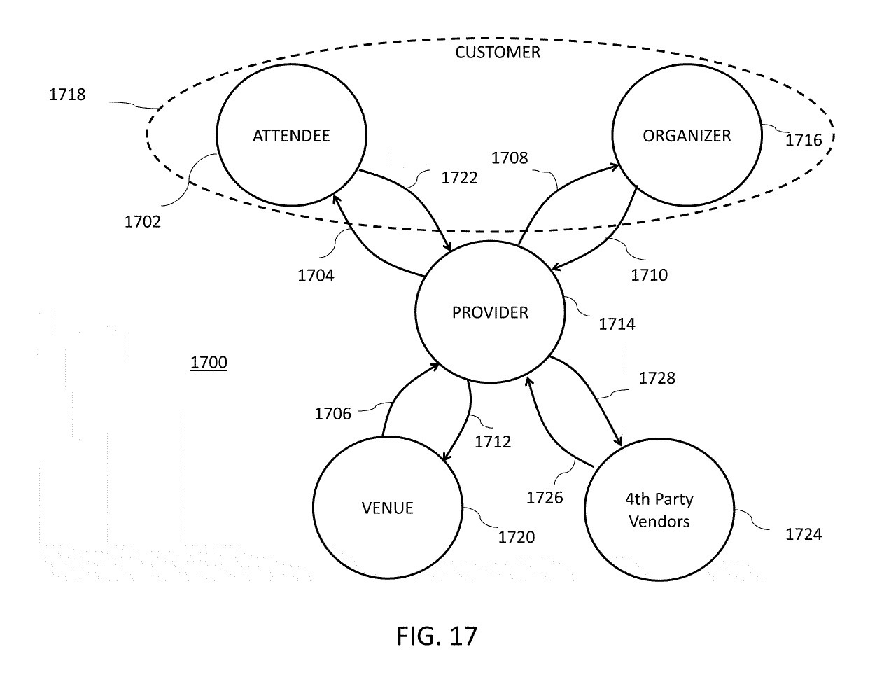

FIG. 17 illustrates an embodiment similar to that of FIG. 6, with the addition of a fourth party entity vendor (1724). For example, the vendor (1724) may be a taxi service, flower arrangement company, event insurance company or other vendor that can provide a service or product which is related to the venue or event operation, but is not directly provided by the venue. The vendor (1724) may communicate, for example, with the provider (1714). Fourth party vendors have been represented outside of the ‘customer’ set (1718) for clarity of explanation, but additional embodiments are possible where the fourth party vendors can be also seen as a customer. Although fourth party vendors and venues have not been discussed with reference to the present figure as being part of the customer subset, the person skilled in the art will understand that, in a different embodiment, both venues and fourth party vendors may be subsets of customers.

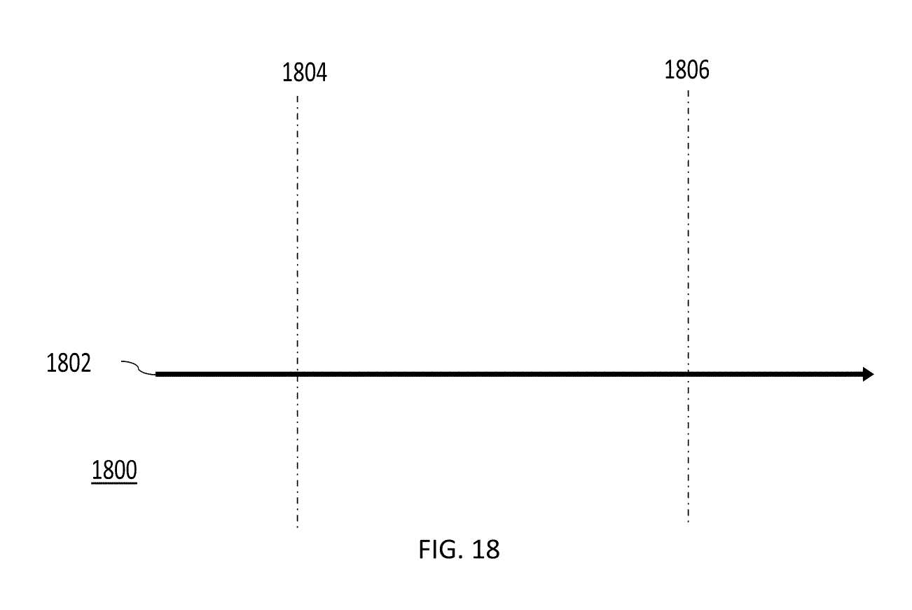

FIG. 18 illustrates sample timelines for an event (1800) with respect to a hotel venue location. The timeline for an event is shown (1802). The time point at which is the venue is selected is displayed as well (1804). Line (1806) shows the time point at which a hotel overnight room block cut-off may expire.

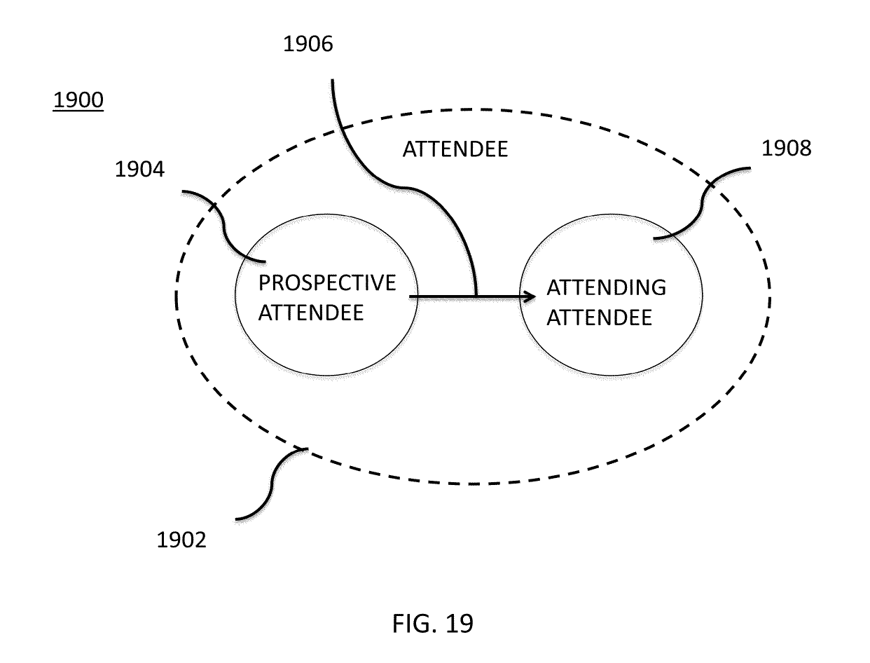

FIG. 19 illustrates how a prospective attendee (1904) may become an attending attendee (1908) upon choosing to (1906) attend an event or venue. FIG. 19 shows that prospective attendees (1904) and attending attendees (1908) are subsets of attendees (1902).

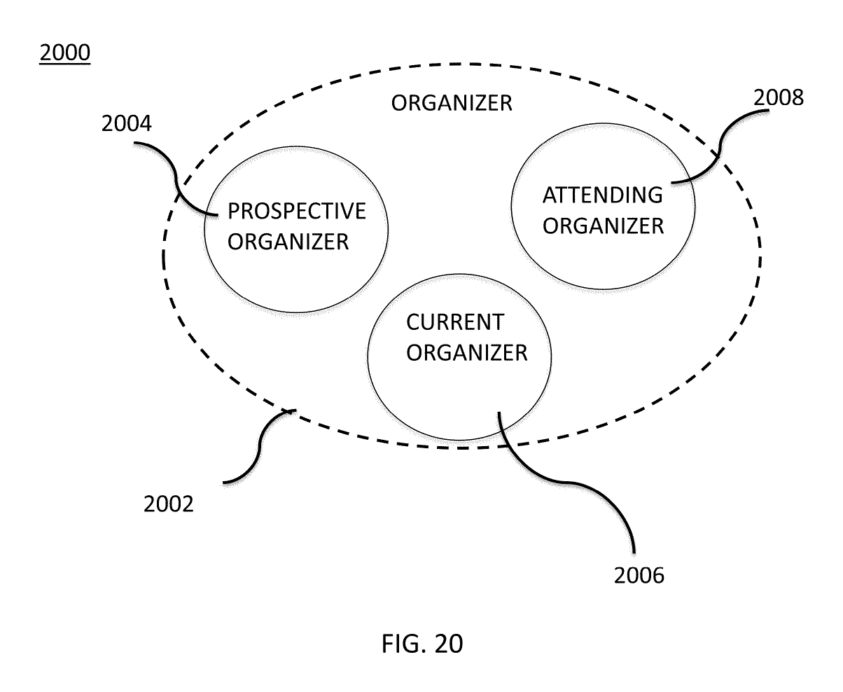

FIG. 20 illustrates how a prospective organizer (2004) and current organizer (2006) and attending organizer (2008) are subsets of an organizer (2002).

In one embodiment, a system to handle all the data and processing described earlier can be realized through a website built using Microsoft .NET® and Unity® platform and combining markup languages, database management tools and programming languages such as HTML/CSS®, Microsoft SQL®, JavaScript®, Python® and C# ®.

In another embodiment other platforms and languages may be used to build such a website.

In some embodiments, venue related decisions can be made, using attendee-related event criteria, past attendee behavior, past organizer behavior, etc., to improve the accuracy of the expected outcome of overnight bookings during the time point at which the hotel overnight room block may expire. Past behavior is intended as based on historical data describing the actions of attendees, organizer or venue. Often hotel venues have a pre-set distribution of overnight rooms for a given group based on their interpretation of an event, which is adjusted for accuracy, in a traditional sense, at the time of cut-off expiry. However, this lack of foresight limits a hotel's ability to properly adjust supply and demand of their room nights, as well as proper supply and demand of the segmentation of their various rooms, be it, king bedrooms, suites, double bedrooms, etc. By introducing an estimation scheme at the time point of venue selection, based on organizer-related event details, attendee-related event details, and venue-related event details, the accuracy of these overnight booking estimations can be significantly improved in advance (as compared to traditional methods used by hotels), allowing for venues to adjust their supply and demand and improve revenue streams, resulting in venue optimization. Venue optimization may be understood, for example, as an improvement in the utilization of the resources available to a venue.

In other embodiments, similar estimation schemes based on attendee, organizer, and venue event details can be used to result in other forms of venue optimization.

In some embodiments, when attendees are suggested to be invited to an event, along with organizer and event optimization, consideration may be given to invite attendees such that venue optimization also occurs.

In some embodiments, once an event is organized, an attendee may send event invitations to prospective attendees.

In some embodiments, providing attendee-related event criteria comprises calculating a desirability factor for a venue based on the attendee-related event criteria.

In some embodiments, the methods and systems of the present disclosure can calculate, by a computer, a likelihood of attendance for at least one prospective attendee; and can further assign, by a computer, a weight to the prospective attendee-related event criteria for at least one prospective attendee. Further, the selecting can comprise establishing a correlation between the venue-related details, the organizer-related event constraints and the prospective attendee-related event criteria based on the weighed prospective attendee-related event criteria.

In some embodiments, the methods and systems of the present disclosure can further organize and optimize, when a venue is selected, event details based on the prospective attendee-related event criteria and the organizer-related event constraints.

In some embodiments, the methods and systems of the present disclosure can further calculate a likelihood of fulfillment for the event to fulfill a minimum attendance requirement for the venue, and further suggest additional attendees to the organizer based on the likelihood of fulfillment for the event, in order to reach the minimum attendance without going above a maximum attendance for the venue.

In some embodiments, the methods and systems of the present disclosure can further sort possible venues in order of desirability based on the organizer-related event constraints, wherein the order of desirability is based on the correlation between the venue-related details, the organizer-related event constraints and the prospective attendee-related event criteria.

In some embodiments, automated recommendation can be provided to suggest possible venues to the organizer, based on venue data and on preference data of previous attendees to events stored in a non-volatile database. Previous attendees are attendees that have previously attended an event.

In some embodiments, establishing a correlation between the venue-related details, organizer-related event constraints and prospective attendee-related event criteria is based on historical data about the behavior of previous attendees to previous events.

In some embodiments, automatic suggestion of event details to an organizer can be based on a rank. The rank may be based on a desirability factor.

In some embodiments, calculating a likelihood of attendance of prospective attendees comprises assigning a weight to the prospective attendee event criteria based on past behavior of the prospective attendee, other attendees or the organizer.

In some embodiments, venue-related details may include, for example, details from the previously discussed portfolio created by the venue. However, the person skilled in the art will understand that details can be provided by other sources, such as vendors or organizers. Reference can also be made, for example, to details such as venue-related, vendor-related or organizer-related details discussed in co-pending U.S. patent application Ser. No. ______, filed concurrently herewith, titled “METHODS AND SYSTEMS FOR IMPROVING SATISFACTION AND DETERMINING ITEM SELECTION AND ASSIGNMENT FOR A GROUP OF USERS” (Attorney Docket No. P1453-US), filed on even date herewith, the disclosure of which is incorporated herein by reference in its entirety.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A computer-implemented method comprising:
providing, by a computer, venue-related details for a venue;
providing, by a computer, organizer-related event constraints;
selecting, by a computer, at least one venue for an event, wherein the venue is selected based on the organizer-related event constraints and wherein the selecting comprises establishing a correlation between the venue-related details and the organizer-related event constraints; and
providing, by a computer, prospective attendee-related event criteria, wherein the selecting further comprises selecting the venue also based on the prospective attendee-related event criteria and wherein the selecting further comprises establishing a correlation between the venue-related details, the organizer-related event constraints and the prospective attendee-related event criteria.

2. The method of claim 1, further comprising checking, by a computer, said venue-related details for accuracy, and storing, by a computer, said venue-related details in a non-volatile database.

3. The method of claim 1, further comprising requesting, by a computer, venue-location preferences to the prospective attendees.

4. The method of claim 1, wherein the selecting, by a computer, at least one venue for the event comprises requesting, by a computer, a new set of event constraints from the organizer.

5. The method of claim 1, further comprising requesting, by a computer, the venue to be available at a specific time and date.

6. The method of claim 1, further comprising requesting, by a computer, attendees of the event to provide an attendee feedback rating regarding at least one of the venue and the event.

7. The method of claim 1, further comprising requesting, by a computer, the organizer to provide an organizer feedback rating regarding the venue.

8. The method of claim 1, further comprising providing, by a computer, automated recommendation of possible venues to the organizer, based on venue data and on preference data of at least one of previous attendees to events stored in a non-volatile database.

9. The method of claim 1, wherein the providing, by a computer, prospective attendee-related event criteria, comprises calculating, by a computer, a desirability factor for one or more venues based on the prospective attendee-related event criteria.

10. The method of claim 1, wherein the establishing a correlation between the venue-related details, organizer-related event constraints and prospective attendee-related event criteria comprises maximizing a correlation between the venue-related details, organizer-related event constraints and prospective attendee-related event criteria.

11. A system to organize an event, the system comprising:
an attendee device, configured to run a first application implementing the method of claim 1;
a venue device, configured to run a second application implementing said method; and
an organizer device, configured to run a third application implementing said method.

12. The system of claim 11, wherein the attendee device, the venue device, or the organizer device are a smartphone, a tablet, a laptop, a portable electronic device or a desktop computer.

13. The method of claim 1, further comprising providing a server configured to connect to prospective attendee computers, venue computers and organizer computer.

14. The method of claim 13, further comprising showing on the organizer computer screen a list of event criteria and/or venues to select.

15. The method of claim 1, wherein an attendee sends event invitations to prospective attendees.

16. The method of claim 1, further comprising requesting, by a computer, to attendees a payment of a fee.

17. The method of claim 1, wherein the establishing a correlation between the venue-related details, organizer-related event constraints and prospective attendee-related event criteria is based on historical data about behavior of previous attendees to previous events.

18. The method of claim 1, further comprising providing, by a computer, a contact list for the organizer, and wherein the prospective attendees are selected from the contact list.

19. The method of claim 1, further comprising providing, by a computer, a global list of prospective attendees for the organizer, and wherein the prospective attendees are selected from the global list.

20. The method of claim 18, wherein the prospective attendees are the entirety of the contact list.

21. The method of claim 1, further comprising:
calculating, by a computer, a likelihood of attendance for at least one prospective attendee; and
assigning, by a computer, a weight to the prospective attendee-related event criteria for the at least one prospective attendee, wherein the selecting further comprises establishing a correlation between the venue-related details, the organizer-related event constraints and the prospective attendee-related event criteria based on the weighed prospective attendee-related event criteria.

22. A computer-implemented method comprising:
providing, by a computer, venue-related details for a venue;
providing, by a computer, organizer-related event constraints;
providing, by a computer, attendee-related event criteria;
selecting, by a computer, event details based on the venue-related details, the attendee-related event criteria and the organizer-related event constraints.

23. The method of claim 22, wherein the event details comprise at least one of catering, seating of users, pick-ups and transportation, room arrangement, roommate matching, meeting room selection, fourth party engagement, budget management, managing event schedules, creating sponsor visibility, and event staff management.

24. The method of claim 22, further comprising automatically suggesting, by a computer, event details to an organizer, based on a rank.

25. The method of claim 21, further comprising:
calculating, by a computer, a likelihood of fulfillment for the event to fulfill a minimum attendance requirement for the venue;
suggesting, by a computer, additional prospective attendees to the organizer based on the likelihood of fulfillment for the event, in order to reach the minimum attendance.

26. The method of claim 21, further comprising:
calculating, by a computer, a likelihood of optimized utilization of venue resources for the venue; and
suggesting, by a computer, additional prospective attendees to the organizer based on the likelihood of optimized utilization of venue resources for the venue.

27. The method of claim 1, further comprising:
sorting, by a computer, possible venues in order of desirability based on at least one of the organizer-related event constraints, the venue-related details, and the prospective attendee-related event criteria.

28. The method of claim 1, further comprising organizing, by a computer, event details based on the attendee-related event criteria and the organizer-related event constraints.

29. An apparatus comprising:
a memory; and
a processor communicatively coupled to the memory, the processor configured to
estimate venue-related details for a venue;
identify organizer-related event constraints; and
execute the method of claim 1.

30. The method of claim 1, wherein the selecting is further based on an availability and cost of a fourth party vendor.

31. The method of claim 21, further comprising:
calculating, by a computer, a likelihood of cancellation for at least one attending attendee.

32. The method of claim 27, wherein the sorting, by a computer, is further based on a risk for the organizer based on historical data.

33. The method of claim 1, further comprising:
calculating, by a computer, a likelihood of attendance for at least one prospective attendee based on the at least one prospective attendee past behavior; and
assigning, by a computer, a weight to the prospective attendee-related event criteria for the at least one prospective attendee based on the at least one prospective attendee past behavior or the organizer past behavior, wherein the selecting further comprises establishing a correlation between the venue-related details, the organizer-related event constraints and the prospective attendee-related event criteria based on the weighed prospective attendee-related event criteria.

34. The method of claim 1, wherein the organizer-related event constraints comprise at least one of date and time of the event, type of the event, desired location of the event, max budget of the event, presence of overnight rooms, amount of event space needed, minimum square footage required for event space, minimum number of event rooms, number of projected attendees, prospective attendee list, minimum square footage of largest event space.
